(19) United States
(12) Patent Application Publication
(10) Pub. No.: US 2026/0237847 A1
(43) Pub. Date: Aug. 13, 2026

(54) Separators with Ion-Exchange Layers and Electrochemical Cells Comprising Such Separators

(71) Applicant: Zelos Energy Ltd., San Leandro, CA (US)

(72) Inventors: Pavel Khokhlov, San Ramon, CA (US); Alireza Ahmadiparidari, Blackhawk, CA (US); Alexander Sasha Gorer, Brisbane, CA (US); Pravati Swain, Fremont, CA (US)

(21) Appl. No.: 19/640,283

(22) Filed: Apr. 6, 2026

Related U.S. Application Data
(63) Continuation-in-part of application No. 19/415,343, filed on Dec. 10, 2025.
Application No. 19/415,343 is a continuation-in-part of application No. 18/800,747, filed on Aug. 12, 2024.

(51) Int. Cl. H01M 50/411; H01M 4/02; H01M 4/24; H01M 4/50; H01M 10/24; H01M 50/291; H01M 50/449; H01M 50/46

(52) U.S. Cl. CPC H01M 50/411; H01M 4/244; H01M 4/50; H01M 10/24; H01M 50/291; H01M 50/449; H01M 50/46; H01M 2004/027; H01M 2004/028

(57) ABSTRACT

A rechargeable battery cell includes a composite separator having a substrate and an ion exchange material supported by the substrate. First and second electrode materials are separated from each other by the separator and an electrolyte contacts the first and second electrode materials and the separator. In some embodiments at least one of the first and second electrode materials includes a zinc (Zn) containing anode. In other embodiments, at least one of the first and second electrode materials includes a cathode including at least one of nickel hydroxide (Ni(OH)₂), nickel oxyhydroxide (NiOOH), activated carbon and manganese dioxide (MnO₂).

### TECHNICAL FIELD

The present disclosure relates generally to the field of batteries and components for batteries. More specifically, the present application relates to batteries or cells that include an ion exchange material and electrodes having contained three-dimensional channels.

### BACKGROUND

There is a great demand for low cost rechargeable battery systems with a high energy density for portable devices, electric vehicles, grid storage and other applications. Recently lithium ion batteries have become a popular technology of choice for many energy storage applications. Unfortunately, limited availability of key metals, high energy costs and safety risks associated with Li-ion technology limit wide adoption of the batteries in many applications.

As an alternative, Zn-based batteries with aqueous electrolytes have been used. The lower cost and relative safety of such batteries allow them to be used in many potential applications.

Unfortunately, zinc secondary batteries can have issues related to growth of zinc dendrites. Despite extensive research and development on batteries such as nickel-zinc secondary batteries and zinc-air secondary batteries, practical implementation is not wide-spread due to formation of zinc dendritic crystals during charging. These dendrites can breach the separator, leading to short circuits with the positive electrode. Consequently, there is a strong demand for techniques that effectively mitigate this issue and enhance the safety and reliability of zinc secondary batteries.

Additionally, there is a concern that common cathode materials demonstrate issues with integrity and consistent chemical composition. Decreases in long-term conductivity caused by the interaction with water based electrolytes is also an issue.

What is needed is battery structures and materials that dramatically extend cycle life and other key parameters of Zn rechargeable batteries.

Also needed are manufacturing procedures that support low cost and ease of battery assembly.

### SUMMARY

In one embodiment a separator can be made from a substrate and an ion exchange material contacting, bonded, and supported by the substrate. A separator is a permeable and usually v thin material placed between a battery's anode and cathode. The main function of a separator is to keep the two electrodes apart to prevent electrical short circuits while also allowing the transport of ionic charge carriers that are needed to close the circuit during the passage of current in an electrochemical cell. A separator formed from a substrate and an ion exchange material can be used in a rechargeable battery cell. In such a rechargeable battery cell, first and second electrode materials are separated from each other by the separator and an electrolyte contacts the first and second electrode materials and the separator. The substrate supported ion exchange material can allow selective flow of ions contained in the electrolyte. For example, an anion exchange layer would allow only conduction of anions and reject flow of cations, while a cation exchange layer would only conduction of cations and reject flow of anions. In some embodiments at least one of the first and second electrode materials includes a zinc (Zn) containing anode. In other embodiments, at least one of the first and second electrode materials includes a cathode including at least one of nickel hydroxide (Ni(OH)2), nickel oxyhydroxide (NiOOH), activated carbon, air electrode or manganese dioxide (MnO₂).

In one embodiment, the separator includes a substrate and an ion exchange material arranged to define an interpenetrating and bonded interface. Providing an interpenetration interface in intimate contact can include completely or partially embedding the substrate in the ion exchange material, or alternatively, surrounding the substrate with a thin film of interpenetrating exchange material. In some embodiments it can be arranged so that ion exchange layer penetrates inside substrate to a depth between 1% and 50% of the thickness of substrate. In some embodiments, non-uniformity of the thickness of ion exchange layer 134 is below 15%.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates a separator having a substrate layer and a substrate supported ion exchange layer;

FIG. 2 illustrates a separator having a substrate layer and a substrate supported ion exchange layer with optional three dimensional structures or internal pores and channels; and

FIG. 3 illustrates a battery including a separator having a substrate layer and a substrate supported ion exchange layer.

### DETAILED DESCRIPTION

The present disclosure relates in part to battery cells having improved cycle life and electrical performance in service. For example, the cells can exhibit higher battery discharge voltage, higher discharge capacity, lower internal resistance, and high-rate discharge capability. In some embodiments, the disclosed battery cells have a long cycle lifetime at high-rate discharge current.

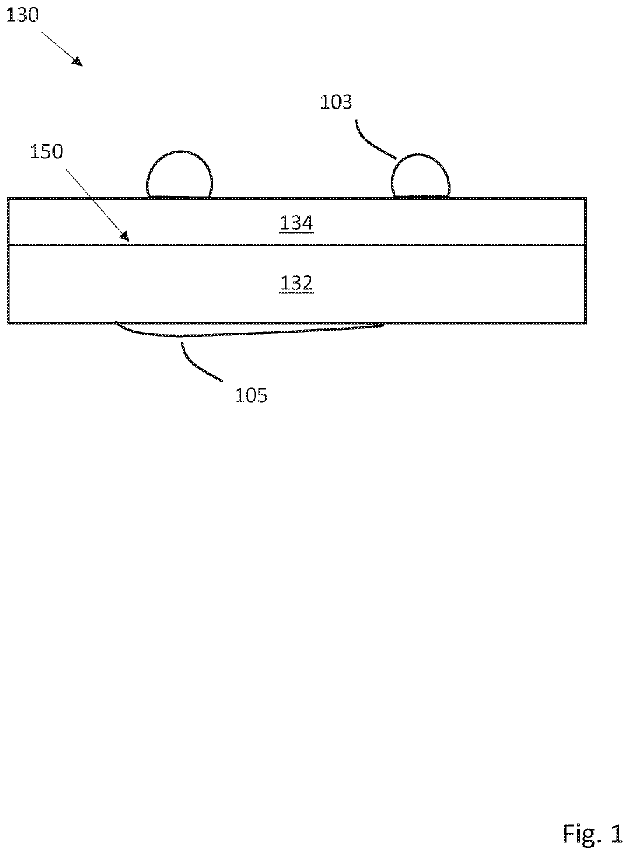

FIG. 1 illustrates a separator 130 that includes a substrate 132 and supports an ion exchange layer 134. Advantageously, the ion exchange layer 134 is hydrophobic, discouraging absorption of water droplets 103, while the supporting substrate 132 can be hydrophilic or otherwise able to absorb and retain water droplets 105.

The separator 130 can be a conventional porous polymer separator and the ion exchange layer 134 can be provided as a polymer membrane, coating, or film. The separator 130 can be flexible or rigid. In some embodiments, the separator is disposed between the anode and the cathode and acts to prevent the anode and the cathode from having internal electrical shorts. In addition, the separator 130 can also act to retain an electrolyte. In some embodiments battery systems can use the same or different cathode and anode electrolyte solutions. The separator is generally required to have a porous structure or a structure having a number of perforations capable of allowing ions to pass while being chemically stable with respect to the electrolyte solution.

In some embodiments the ion exchange layer 134 includes ion exchange material that is preferentially positioned on one or both side of the substrate. In some embodiments the ion exchange material on one side can be chemically or mechanically or otherwise different from the ion exchange material positioned on the opposite side. In other the ion exchange layer 134 forms non-porous continuous film on the substrate. In some embodiments the ion exchange material forms a porous layer with pore size preferably less than 1 micron.

In some embodiments the substrate 132 can have a thickness that ranges between 5 and 250 microns. The ion exchange layer 134 can have a thickness that ranges between 1 and 125 microns. Further, in some embodiments an interface 150 between the substrate 132 and the ion exchange layer 134 can be smooth, rough, or even interpenetrating. For example, it can be arranged so that ion exchange layer 134 penetrates inside substrate 132 to a depth between 1% and 50% of the thickness of substrate 132. In some embodiments, non-uniformity of the thickness of ion exchange layer 134 is below 15%. Areal loading can be selected to be between 0.1 mg/cm2 and 20 mg/cm2, while area resistance can be selected to be between 0.05 Ohm^{cm2} and 10 Ohm^{cm2}. The resulting structure can be airtight as measured by a bubble point pressure test.

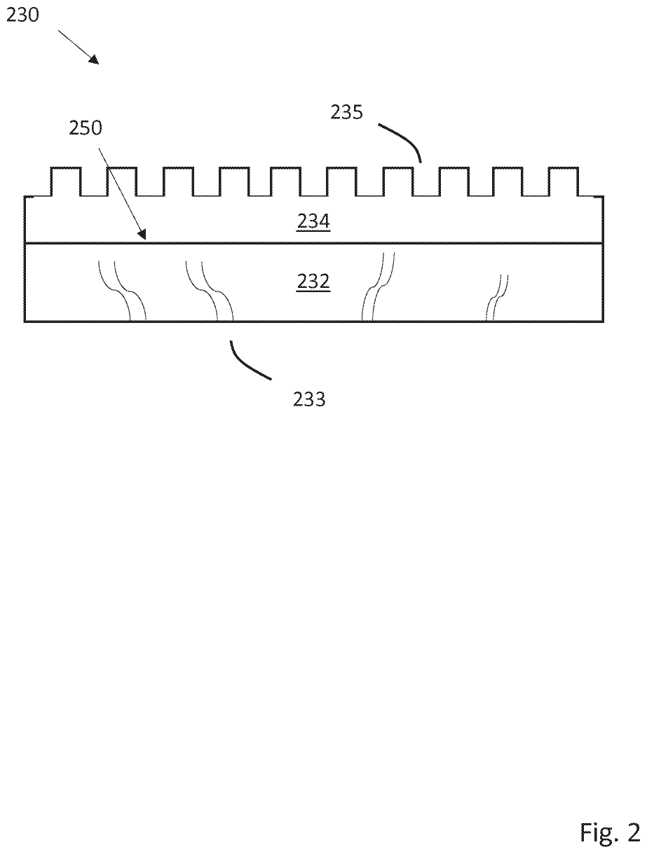

FIG. 2 illustrates one embodiment of a separator 230 with a substrate 232 and an ion exchange layer 234. Similar to the embodiment described with respect to FIG. 1, in some embodiments an interface 250 between the substrate 232 and the ion exchange layer 234 can be smooth, rough, or even interpenetrating. One or both the substrate 232 and an ion exchange layer 234 can also be configured to increase separator area in contact with electrolyte material. In this embodiment, stamping or embossing is used to create a three dimensional structure 235 in the ion exchange layer 234 that increase contact with electrolyte material. In other embodiments, the substrate 232 can include pores or channels 233 that increase contact with electrolyte material. In still other embodiments, increased contact with electrolyte material can be provided through use of substrate foams, a three dimensional lattice network, use of inner voids connected to external pores, and inclusion of either “tangled” or disordered channel structures. In some embodiments, three-dimensional channels can have a regular or ordered layout. Advantageously, in some embodiments a combination of sponge network and a large number of interconnected three-dimensional channels or voids can be used. Long term soaking or use of a vacuum system can be used to draw electrolyte material into the three-dimensional channels. Alternatively or in addition, liquid electrolyte can be drawn inside the substrate due to the capillary forces. In some embodiments, feature size of embossed, stamped, or manufactured three dimensional structures or pore sizes in the substrate 232 or ion exchange layer 234 can range from 50 nm to 200 microns.

As will be understood, in various embodiments, either both or one of the substrate 232 and an ion exchange layer 234 can be stamped, embossed, or other formed or modified to have the discussed three dimensional structures. Similarly, both or one of the substrate 232 and an ion exchange layer 234 can include pores, channels, or other three dimensional internal structures.

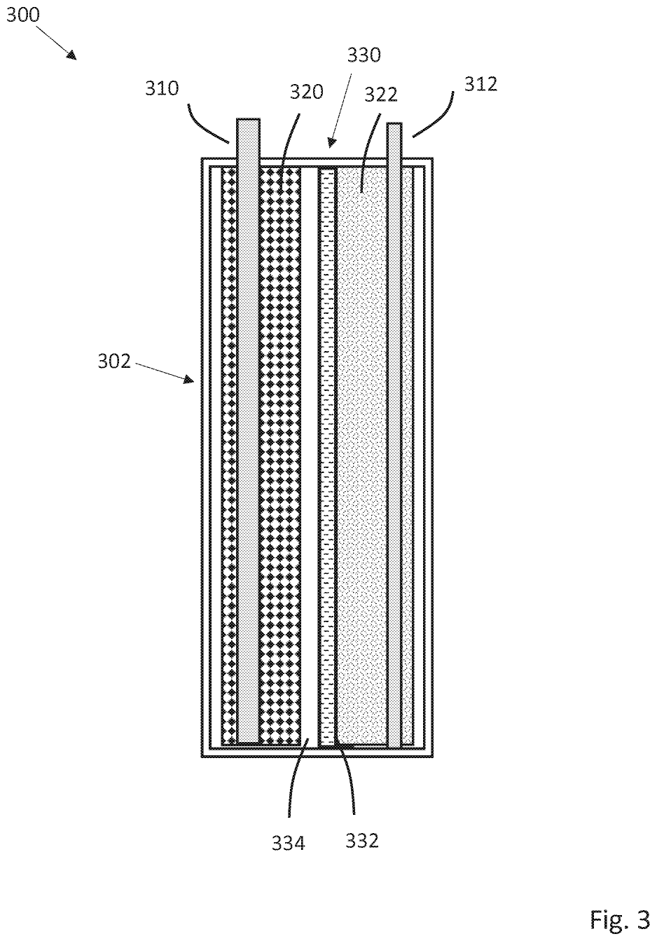

FIG. 3 illustrates a rechargeable battery cell system 300 that includes a casing 302 that surrounds various battery components. Battery components can include current collectors 310 and 312 that facilitate charge and discharge of the battery cell system 300. Other components include electrode material 320 and 322 that respectively contact current collectors 310 and 312. The current collectors 310 and 312 can be fully (as shown) or partially embedded in electrode material 320 or 322. In some embodiments, the current collectors can be attached to one or more surfaces of either or both the electrode material 320 or 322.

The electrode material 320 and 322 can be separated from each other by a separator 330 with substrate 332 and an ion exchange layer 334 that only permits ion flow between the material. The rechargeable battery cell system 300 can include anode, cathode, ion exchange, and other materials and components as described in the following:

### Electrodes

Electrode material can include solid continuous pore structures, including but limited to multiple interconnected three-dimensional channels in electrode material that form a highly porous, rigid and monolithic, and/or sponge-like structure. In some embodiments, all or part of an electrode can also be formed as thin films, or structured patterns such as columns, needles, groove, or slots. In some embodiments electrodes can be loosely arranged materials, rigidly bound or sintered structures. In one embodiment, electrodes can be formed from particles provided in various forms such as powders, granules, pellets, or nanomaterial. In certain embodiments, particles can have an average size (diameter or longest dimension) of between about 0.05 μm to 300 μm, and in a specific embodiment, between about 1 μm and 100 μm. In some embodiments, relatively homogeneous particle sizes can be used, while in other embodiments heterogenous sized materials can be used. Particles can be processed to increase effective surface area. In some embodiments, particles can be processed by heating, melting, fusing, or sintering to bind together the particles. In other embodiments, additional binders can be used to hold particles together.

### Collectors

At least a portion of electrode material can be embedded or placed in contact with a current collector. The current collector serves to supply an electric current so that it can be consumed for the electrode reaction during charge and collect an electric current generated during discharge. The current collector is typically formed from a material which has a high electrical conductivity and is inactive to electrochemical battery cell reaction. The current collector may be shaped in a plate form, foil form, mesh form, porous form-like sponge, punched or slotted metal form, or expanded metal form.

The material of the current collector can include Ni, Ti, Cu, Al, Pt, V, Au, Zn, and alloys of two or more of these metals such as stainless steel. Other embodiments can graphite cloth, copper sheet or mesh slotted woven brass.

### Anode Material

Anode materials for an electrode can include a wide range of materials such as zinc, aluminum, magnesium, iron, and lithium and other metals in pure oxide form or salt form, or combinations thereof. In some embodiments, relatively pure Zn, ZnO or a mixture of Zn and ZnO can be used. For a rechargeable zinc negative electrode, the electrochemically active material can be manufactured from zinc oxide powder or a mixture of zinc and zinc oxide powder. The zinc oxide can dissolve in an alkaline electrolyte to form the zincate (Zn(OH)₄²⁻). Zinc oxide or/and zincate is reduced to zinc metal during the charging process.

More broadly, anode materials can include:

Any metal M, metal oxide MOx or metal salt having a redox potential E0 lower than the redox potential of the cathode material.

Any metal oxide MOx having a standard potential E0 lower than the redox potential of the cathode material.

Any alloy of any metals MM1M2 . . . Mn, mixed oxides or mixed salts having a E0 lower than the E0 of the cathode material.

Any polymer that can accommodate anions in its structure having a redox potential E0 lower than the redox potential of the cathode material.

Any mixture of one or more of the above mentioned type of materials.

### Cathode Material

Cathode material for an electrode can include a wide range of materials such as metal or metal containing compounds such as Fe⁶⁺, Mn⁷⁺, nickel hydroxide Ni(OH)₂, nickel oxyhydroxide NiOOH, manganese dioxide MnO₂, copper oxide, bismuth oxide, air electrodes, or any combinations. Carbons and activated carbons may also serve as active material of cathode.

More broadly, cathode materials can include:

Any metal M having a redox potential E0 larger than the redox potential of the anode material.

Any metal oxide MOx having a redox potential E0 larger than the redox potential of the anode material.

Any alloy of any metals MM1M2 . . . Mn having a E0 larger than the E0 of the anode material.

Any metal fluoride MFn having a redox potential larger than the anode material.

Any alloy MM1M2 . . . MnOxFm with n larger or equal to 2 and m being larger or equal to zero.

Any polymer that can accommodate anions in its structure having a redox potential E0 larger than the redox potential of the anode material.

CFx carbon fluoride with x being between zero and 2.

Unstable salts not stable in aqueous electrolyte solutions, including but not limited to FeVI (iron six) based battery systems.

Any type of carbon (including activated carbons, high surface area carbons or graphites.

Any mixture of one or more of the above mentioned type of materials.

### Additives and Binding Agents

Various additives can be used to improve electrochemical, electrical, or mechanical features of the electrodes. For example, electrochemical performance can be improved by addition of nickel, nickel hydroxide, nickel oxyhydroxide, or nickel oxide containing cathode material that can incorporate or be coated with small amounts of cobalt oxide, strontium hydroxide (Sr(OH)₂), barium oxide (BaO), calcium hydroxide (Ca(OH)₂), Fe₃O₄, calcium fluoride (CaF₂), or yttrium oxide (Y₂O₃) to improve battery cell performance. As another example, electrode can includes an oxide such as bismuth oxide, indium oxide, and/or aluminum oxide. Bismuth oxide and indium oxide may interact with zinc and reduce gassing at the electrode. Bismuth oxide may be provided in a concentration of between about 1 and 10% by weight of a dry negative electrode formulation. Indium oxide may be present in a concentration of between about 0.05 and 1% by weight of a dry negative electrode formulation. Aluminum oxide may be provided in a concentration of between about 1 and 5% by weight of a dry negative electrode formulation.

In certain embodiments, one or more additives may be included to improve corrosion resistance of the zinc electrode material. Specific examples of anions that may be included to reduce the solubility of zinc in the electrolyte include phosphate, fluoride, borate, zincate, silicate, or stearate. Generally, these anions may be present in an electrode in concentrations of up to about 10% by weight of a dry electrode formulation.

Additives that improve electrical characteristics such as conductivity can also be added. For example, a range of carbonaceous materials can be used as electrode additives, including powdery or fibrous carbons such as graphite, coke, ketjen black, and acetylene black. Carbonaceous nanomaterials can also be used such as single or multiwalled carbon nanotubes, carbon nanofibers, multi-layered carbon nanoparticles, carbon nanowhiskers, or carbon nanorods.

Additives may be provided as chemically homogeneous components into a mixture or solution, co-precipitated, or coated onto particles

Mechanical properties can be improved in one embodiment by addition of binding agents to provide increased electrode mechanical strength, and flexure or crack reduction for the electrode. Binding agents may include, for example, polymeric materials such as polytetrafluoroethylene (PTFE), polyethylene (PE), polypropylene (PP), polyisobutylene (PIB), polyvinyl alcohol (PVA), polyacrylic acid, polyvinyl acetate, carboxy methyl cellulose (CMC), styrene butadiene rubber (SBR), polyethylene oxide (PEO), polybutylene terephthalate (PBT) or polyamides, polyvinylidene fluoride (PVDF), silicone-based elastomers such as polydimethyl siloxane (PDMS) or rubber materials such as natural rubber (NR), ethylene propylene rubber (EPM) or ethylene propylene diene

### Ion Exchange Material

The ion exchange material is generally selective for the transport of either cations or anions. An anion selective ion exchange material can be used alone, a cation selective ion exchange material can be used alone, or they can be used in combination with each other. In one embodiment the ion exchange material can be an organic or polymeric material having attached strongly acidic groups, such as sulfonic acid including, sodium polystyrene sulfonate, or poly AMPS. Alternatively, the ion exchange material can be an organic or polymeric material having attached strongly basic groups, such as quaternary amino groups including trimethylammonium groups (e.g. polyAPTAC). In another embodiment, the ion exchange material can be an organic or polymeric material having attached weakly acidic groups, including carboxylic acid groups. Alternatively, the ion exchange material can be an organic or polymeric material having attached weakly basic groups, typically featuring primary, secondary, and/or tertiary amino groups (e.g. polyethylene amine).

The ion exchange can be provided to interact with electrode material as a fully or partially embedding polymer, a particle mixture, a membrane or film, particulates or beads, or a coating. The anode alone, the cathode alone, or both the anode or cathode can be configured to interact with an ion exchange material, which can be the same or different material for the respective electrodes.

### Electrolyte

An electrolyte is used to maintain high ionic conductivity between electrodes. Electrolytes can be aqueous based, solvent based, solid polymer, or an ionic liquid. In some embodiments, electrolytes can be semi-solid or gelatinized. Gelatinizing agents can include polymers that absorb the liquid of the electrolyte solution and swell. Such polymers can include polyethylene oxide, polyvinyl alcohol, and polyacrylamide.

In another embodiment the electrolyte can be a solid state electrolyte. In another embodiment electrolyte can be formed as a solid material with absorbed water. For example, KOH exposed to humid air.

In another embodiment electrolytes can be formed from ion exchange material such as explained above under “Ion exchange material” section.

In one embodiment aqueous alkaline electrolytes can be used. Alkaline electrolytes can include alkalis such as potassium hydroxide, sodium hydroxide, lithium hydroxide, calcium hydroxide or inorganic salts such as zinc bromide.

### Separator

A separator may be replaced with (or used in conjunction with) an ion exchange membrane or film. A conventional porous polymer separator or ion exchange separator may be provided as a polymer membrane or film. Typically, a separator is disposed between the anode and the cathode and acts to prevent the anode and the cathode from having internal electrical shorts. In addition, the separator can also act to retain the electrolyte, particularly for battery systems that use different cathode and anode electrolyte solutions. The separator is generally required to have a porous structure or a structure having a number of perforations capable of allowing ions to pass while being chemically stable with respect to the electrolyte solution. In some embodiments, one or more separators can be formed by coating electrodes or particles that collectively form an electrode. The separator can be formed from a nonwoven fabric or a membrane having a micropore structure made of glass, polypropylene, polyethylene, resin, or polyamide. Alternatively, the separator may be constituted by a metal oxide film or a resin film combined with a metal oxide respectively having a plurality of perforations.

### Processing

In one embodiment, a dry mixing process can be performed in which various anode and cathode materials, as well as additives and binders are mixed while dry. Optional processing steps such as heating, fusing, compressing, and melting ion exchange material can be performed before placing the mixture in a battery casing. In other embodiments, optional processing steps such as heating, fusing, compressing, and melting ion exchange material can be performed after placing the mixture in a battery casing. A liquid electrolyte can be added before sealing the battery casing.

According to other embodiments, a wet mixing process may instead be utilized. In a wet mixing process, one or more solvents are added at the beginning or during the mixing process, or, alternatively, one or more ingredients may be used in the form of a dispersion or suspension. The solvent(s) can be subsequently removed after the mixing process or later state in the production process.

In other embodiments, embodiment, the various individual components may be made using different methods. For example, some of the electrode may be produced using a dry mixing process, while portions of the electrode may be produced using a wet process. According to yet another embodiment, it is possible to combine both dry and wet processes for the different components. In still other embodiments, electrodes can be formed into monolithic blocks with three-dimensional channels or pores extending therethrough by sintering particles, drilling or subtractive manufacture, additive manufacture, chemical fusion, or use of additional adhesives, epoxies, or binders.

### Battery and Cell Design

The battery cells of this invention can have any of a number of different shapes and sizes. For example, coin, prismatic, pouch or cylindrical cells can be used. Cylindrical cells of this invention may have the diameter and length of conventional AAA cells, AA cells, A cells, C, or D cells. Custom cell designs can be used in some applications. For example, prismatic cell designs can be used for portable or vehicular applications, as well as various larger format cells employed for various non-portable applications. A battery pack can be specifically designed for particular tools or applications. Battery packs can include one or more battery cells and appropriate casing, contacts, and conductive lines to permit reliable charge and discharge in an electric device. In some embodiments, electrodes can be sized to exactly fit within a casing of conventional AAA cells, AA cells, A cells, C, D cells, or other known or custom cell sizes. This can include manufacture and placement into a casing of a monolithic anode including at least one of zinc or zinc oxide and sized to exactly match the casing. This can include, for example, a bobbin style AA cell.

### Example 1

In the foregoing description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The foregoing detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. An electrochemical cell comprising:
a positive electrode comprising a positive active material;
a negative electrode comprising one or more of zinc and zinc oxide as a negative active material; and
a separator positioned between the positive electrode and the negative electrode, wherein:
the separator comprises a porous substrate and an ion exchange layer laminated to at least one side of the substrate,
the substrate comprises a material selected from the group consisting of glass, polyethylene, polypropylene, cellulose, resin, and polyamide,
the ion exchange layer comprises one or more functional groups selected from a carboxylic acid group, a quaternary ammonium group, an ammonium group, a phosphonium group, and a sulfonium group, and
the ion exchange layer faces the negative electrode.

2. The electrochemical cell of claim 1, wherein the ion exchange layer is substantially non-porous with a porosity less than 5%.

3. The electrochemical cell of claim 1, wherein the substrate has a porosity between 40-80% before coating with the ion exchange layer.

4. The electrochemical cell of claim 1, wherein the ion exchange layer forms an interpenetrating interface with the substrate.

5. The electrochemical cell of claim 1, wherein the ion exchange layer is microporous with pore sizes smaller than 1 micrometer.

6. The electrochemical cell of claim 1, wherein the ion exchange layer has a thickness of 10-90 micrometers.

7. The electrochemical cell of claim 1, wherein the substrate has a thickness between 10-50 micrometers.

8. The electrochemical cell of claim 1, wherein the substrate is hydrophilic, and the ion exchange layer is hydrophobic.

9. The electrochemical cell of claim 8, wherein the negative electrode further comprises additives selected from bismuth oxide, indium oxide, or aluminum oxide.

10. The electrochemical cell of claim 1, wherein the substrate comprises a non-woven polymeric layer.

11. The electrochemical cell of claim 1, wherein the ion exchange layer comprises a base polymer such that one or more functional groups are on 10-50% of repeating units of the base polymer.

12. The electrochemical cell of claim 11, wherein the base polymer is selected from the group consisting of polystyrene, polysulfone, polyethersulfone, and polyphenylene oxide.

13. The electrochemical cell of claim 1, wherein the ion exchange layer exhibits an electrolyte absorption rate of less than 5%.

14. The electrochemical cell of claim 1, wherein the substrate absorbs at least 20% of its weight in electrolyte.

15. A method of fabricating an electrochemical cell, the method comprising:
fabricating a positive electrode comprising manganese dioxide as a positive active material;
fabricating a negative electrode comprising one or more of zinc and zinc oxide as a negative active material;
fabricating a separator comprising a substrate and an ion exchange layer laminated on at least one side of the substrate, wherein:
the substrate comprises a material selected from the group consisting of glass, polyethylene, polypropylene, cellulose, resin, and polyamide, and
the ion exchange layer comprises one or more functional groups selected from a carboxylic acid group, a quaternary ammonium group, an ammonium group, a phosphonium group, and a sulfonium group; and
arranging the positive electrode, the separator, and the negative electrode such that the separator is positioned between the positive electrode and the negative electrode and such that the ion exchange layer faces the negative electrode.

16. The method of claim 15, wherein fabricating the separator comprises laminating the ion exchange layer to the substrate.

17. The method of claim 15, wherein fabricating the separator comprises laminating the ion exchange layer to the substrate using heat and pressure.

18. The method of claim 17, wherein laminating the ion exchange layer to the substrate comprises applying heat at a temperature of 50-160° C.

19. The method of claim 15, further comprising pretreating the ion exchange layer to introduce ion-selective species into the ion exchange layer by exposing the ion exchange layer to an aqueous alkaline solution to exchange counter-ions associated with functional groups of the ion exchange layer.

20. The method of claim 19, wherein the aqueous alkaline solution comprises potassium hydroxide at a concentration of 5-30% by weight, and wherein exposing the ion exchange layer is performed at 15-40° C. for 2-24 hours.
